(19) United States
(12) Patent Application Publication
(10) Pub. No.: US 2007/0092295 A1
(43) Pub. Date: Apr. 26, 2007

(54) MULTI-COLOR LASER-ETCHED IMAGES

(76) Inventors: CarrDella T. Price, Las Vegas, NV (US); Thomas M. Price, Las Vegas, NV (US)

Correspondence Address: KENEHAN & LAMBERTSEN, LTD;JOHN C LAMBERT, 1771 E. FLAMINGO ROAD, SUITE 117B, LAS VEGAS, NV, 89119-0839, US

(21) Appl. No.: 11/551,601

(22) Filed: Oct. 20, 2006

Related U.S. Application Data
(60) Provisional application No. 60/596,803, filed on Oct. 21, 2005.

(51) Int. Cl. G03G 15/05

(52) U.S. Cl. 399/135

(57) ABSTRACT

A color image is fused on a hard surface by a laser beam. A first color layer of toner particles is fused in accordance with a first color separation of a color image at a first screen angle. A second color layer of toner particles is fused in accordance with a second color separation of a color image at a second screen angle. A third color layer of toner particles is fused in accordance with a third color separation of a color image at a third screen angle. A fourth color layer of toner particles is fused in accordance with a fourth color separation of a color image at a fourth screen angle. The screen angles and offsets of the focal point of the laser beam are selected for each color to optimize the colors fused onto the surface.

### RELATED APPLICATIONS

The present application claims the benefit of priority under 35 U.S.C. § 119(e) to U.S. Provisional Application No. 60/596,803, filed on Oct. 21, 2005.

### BACKGROUND OF THE INVENTION

1. Field of the Invention

The present invention is related to systems and methods for forming multicolor images on hard surfaces using lasers to burn colored toner particles onto the hard surface at selected locations.

2. Description of the Related Art

Establishing permanent images on such “hard” surfaces as ceramics, glasses, marble, granite, and the like, has traditionally relied upon fired glazes, with the images fused to the surface. Image resolution is dependent upon the size of the smallest (in area) recognizable color and in the ability for precise placement of such areas of color. Traditional glazes and application methods permitted only grossly-formed images—compositions consisting of larger blocks and lines of color.

Digital images are now readily available, as is the equipment required to produce them. Glaze-fused images have not been able to take advantage of digital technology due to the inability to use traditional methods to reproduce areas of color at anywhere near the pixel level. A need exists to transfer digitized images to ceramics and glasses in a manner that results in highly resolved, full color fused images.

### SUMMARY OF THE INVENTION

An aspect in accordance with embodiments of the present invention is a color image fused on a hard surface by a laser beam. A first color layer of toner particles is fused in accordance with a first color separation of a color image at a first screen angle. A second color layer of toner particles is fused in accordance with a second color separation of a color image at a second screen angle. A third color layer of toner particles is fused in accordance with a third color separation of a color image at a third screen angle. A fourth color layer of toner particles is fused in accordance with a fourth color separation of a color image at a fourth screen angle. The screen angles and offsets of the focal point of the laser beam are selected for each color to optimize the colors fused onto the surface.

Another aspect in accordance with embodiments of the present invention is hard-surfaced substrate having a color image formed on a surface. The color image comprises at least a first layer of toner particles of a first color, a second layer of toner particles of a second color and a third layer of toner particles of a third color. The toner particles of the first color are burned onto selected locations of the surface as color dots of the first color in accordance with digital data representing a first color separation of a color image at a first screen angle. The toner particles of the second color are burned onto selected locations of the surface as color dots of the second color in accordance with digital data representing a second color separation of a color image at a second screen angle, which is different than the first screen angle. The toner particles of the third color are burned onto selected locations of the surface as color dots of the third color in accordance with digital data representing a third color separation of a color image at a third screen angle, which is different than the first screen angle and the second screen angle.

Preferably, the color image on the surface further comprises a fourth layer of black toner particles laser burned onto selected locations of the surface as black color dots in accordance with digital data representing a fourth color separation at a fourth screen angle, which is different than the first screen angle, the second screen angle and the third screen angle. Preferably, the toner particles of the first color are burned onto the surface to form color dots of a first size, the toner particles of the second color are burned onto the surface to form color dots of a second size, the toner particles of the third color are burned onto the surface to form color dots of a third size, and the black toner particles are burned onto the surface to form color dots of a fourth size. In certain embodiments the first color is Cyan, the second color is Magenta; the third color is Yellow. In such embodiments, the second size and the third size are larger than the first size, and the fourth size is approximately the same as the first size.

In particularly preferred embodiments, the toner particles of the first color are burned onto the surface by a laser beam focused a first distance from the surface. The toner particles of the second color are burned onto the surface by a laser beam focused a second distance from the surface, wherein the second distance greater than the first distance. The toner particles of the third color are burned onto the surface by a laser beam focused a third distance from the surface, wherein the third distance greater than the first distance. The black toner particles are burned onto the surface by a laser beam focused at a fourth distance from the surface, wherein the fourth distance approximately the same as the first distance.

Another aspect in accordance with embodiments of the present invention is a method of forming a high-resolution color image on a hard-surfaced substrate. In accordance with the method, a digitized color image is separated into at least first, second and third digital images representing the components of respective first, second and third colors in the digitized color image by using respective first, second and third screen angles. A first toner layer having particles corresponding to the first color is placed on a surface of the hard-surfaced substrate. The hard-surfaced substrate is positioned with the surface proximate a digitally controlled laser source and is offset from the focal point of the laser source by a first offset distance. Digital signals are applied to the digitally controlled laser beam to apply laser energy to selected portions of the surface to fuse the particles corresponding to the first color on the surface. Unfused portions of the first toner layer are removed from the surface. A second toner layer having particles corresponding to the second color is placed on the surface of the hard-surfaced substrate. The hard-surfaced substrate is positioned with the surface proximate a digitally controlled laser source and is offset from the focal point of the laser source by a second offset distance. Digital signals are applied to the digitally controlled laser beam to apply laser energy to selected portions of the surface to fuse the particles corresponding to the second color on the surface. Unfused portions of the second toner layer are removed from the surface. A third toner layer having particles corresponding to the third color is placed on the surface of the hard-surfaced substrate. The hard-surfaced substrate is positioned with the surface proximate a digitally controlled laser source and is offset from the focal point of the laser source by a third offset distance. Digital signals are applied to the digitally controlled laser beam to apply laser energy to selected portions of the surface to fuse the particles corresponding to the third color on the surface. Unfused portions of the third toner layer are removed from the surface.

In preferred embodiments of the method, the digitized color image is further separated into at least a fourth digital image representing the black component of the digitized color image by using a fourth screen angle. A fourth toner layer having black particles is placed on the surface, and the hard-surfaced substrate is positioned with the surface proximate the digitally controlled laser and offset from the focal point of the laser source by a fourth offset distance. Digital signals are applied to the digitally controlled laser beam to apply laser energy to selected portions of the surface to fuse the black particles on the surface. Unfused portions of the fourth toner layer are removed from the surface.

Preferably, the toner particles of the first color are burned onto the surface to form color dots of a first size. The toner particles of the second color are burned onto the surface to form color dots of a second size. The toner particles of the third color are burned onto the surface to form color dots of a third size. The black toner particles are burned onto the surface to form color dots of a fourth size.

In certain embodiments of the method, the first color is Cyan, the second color is Magenta, and the third color is Yellow. In such embodiments, the second size and the third size are larger than the first size, and the fourth size is approximately the same as the first size. Preferably, the first offset distance and the fourth offset distance are approximately the same, the second offset distance is greater than the first offset distance, and the third offset distance is greater than the first offset distance.

### BRIEF DESCRIPTIONS OF THE DRAWINGS

The foregoing aspects and other features of embodiments in accordance with the present invention are described in more detail below in connection with the attached set of drawings in which:

FIG. 1 is a top plan view showing an arrangement of hard surface substrates that cooperatively recreate a widely known artistic image;

FIG. 2 is an enlarged plan view of the hard surface substrate within circle-A in FIG. 1;

FIG. 3 is a schematic representation of multiple separate screen angles used to generate the color separations used to control the fusing of toner particles of different colors across a hard surface substrate when creating a graphic image thereon;

FIG. 4A is an enlarged partial perspective/schematic view depicting the establishment of an initial laser separation image on a hard surface substrate;

FIG. 4B is an enlarged partial perspective/schematic view depicting an establishment of a second laser separation image in the hard surface substrate of FIG. 4A;

FIG. 4C is an enlarged partial perspective/schematic view depicting an establishment of a third laser separation image in the hard surface substrate of FIG. 4A; and

4D is an enlarged partial perspective/schematic view depicting an establishment of a fourth laser separation image in the hard surface substrate of FIG. 4A.

### DETAILED DESCRIPTIONS OF THE PREFERRED EMBODIMENTS

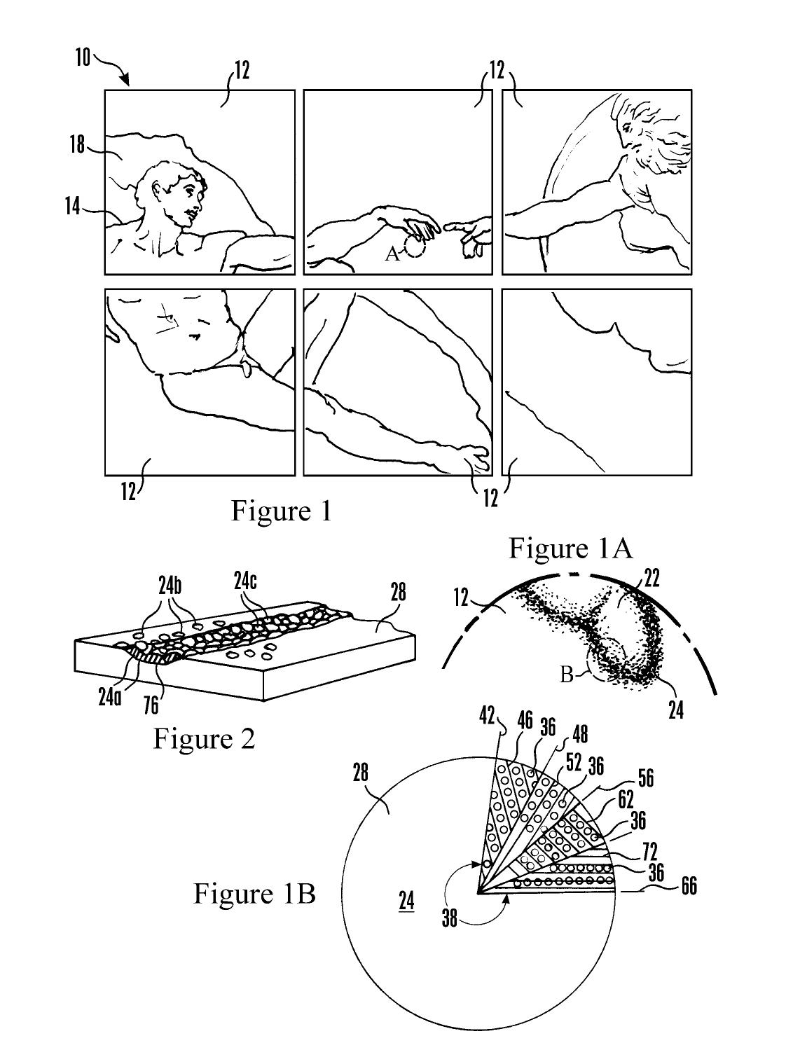

Reference is now made to the drawings wherein like numerals refer to like parts throughout. In FIG. 1, a graphic image 10 is formed utilizing a plurality of ceramic tiles 12 that cooperatively create a reproduction of a well-known work of art, God and Adam, a fresco by Michelangelo on the ceiling of the Sistine Chapel. In this particular vignette, God is depicted as providing the “spark of life” to his creation: a man 14, “Adam;” who is shown resting upon a mountain 18.

The graphic image 10 is depicted primarily as line drawings; however, it is to be understood that the remaining surfaces of the ceramic tiles 12 include areas of different colors and shadings associated with this same work of art. The lines too are not the result of a smooth application of a pigment, as is best shown by reference to FIG. 1A. In this example a plurality of colored dots forms rosettes when mixed to define an outer surface of a finger 22 from the man 14 (“Adam”). The colored dots are in fact a plurality of individually-applied colored particles 24 that are fused to the surface of the ceramic tile 12. The plurality of individual colored particles 24 are co-located in a manner that creates one or more visual illusions to the human eye, as will be hereinafter discussed in greater detail.

The individual colored particles 24 are the result of a cumulative process wherein a 4-color digitized image is filtered into separate colors using a color separation process to produce a respective halftone screen image for each color. The colors are then sequentially applied to a ceramic surface one color layer at a time. Turning now to FIG. 1B, a portion of a hard substrate surface 28 is depicted as having a plurality of fused colored particles layered thereon. Each of the separate colors is independently fused a layer at a time by a laser light source from a respective halftone color separation produced at a separate screen angle, permitting the several layers of overlaid color to overlap where necessary to produce color blends.

In FIG. 1B, a plurality of individual color dots (sometimes referred to as pixels) 36 are depicted as small circles, with all the dots located within a first quarter 38 of the circle of the hard substrate surface 28. A number of individual sectors have been inscribed in the first quarter 38 and are intended to schematically illustrate the sequential application of the separate colors that together comprise the graphic image. In the actual image, the dots of different colors are selectively overlapped in areas by the imaging software to produce many variations in colors in accordance with the densities of the dots of the different colors in a particular portion of the image.

Analogous to inks printed on paper, the application of the graphic images to the hard substrate surface 28 utilizes the CMYK “subtractive” color pallet. As white light strikes the translucent pigments, part of the spectrum is absorbed and part is reflected back to the viewer. The theoretically pure Cyan (“C”), Magenta (“M”), and Yellow (“Y”) pigments should combine to absorb all color; and produce black. The real world pigment impurities result instead in a muddy brown, requiring the application of a Black pigment (“K”) to produce a true black.

In a first sector 42, a Cyan image is burned into the hard substrate surface 28 at a Cyan burn angle 46 and at a certain laser power setting. As used herein the Cyan “burn angle” refers to the halftone screen angle used in a color separation process to produce a grayscale representation of the Cyan components of the original image. The selected halftone screen angles for each color in the color separation reduce or prevent the moire patterns that occur when each of the colors is reproduced at the same screen angle.

A second sector 48 illustrates the burning of a Magenta image into the hard substrate surface 28 at a Magenta burn angle 52—at a selected laser power setting for Magenta.

A third sector 56 reveals the burning of a Yellow image into the hard substrate surface 28 at a Yellow burn angle 62 and a selected laser power setting for Yellow.

A fourth sector 66 illustrates the laser burning of a black image into the hard substrate surface 28 at a black burn angle 72 and at a selected laser power setting for black.

The combinations of the three colors and black in very small dot patterns cause a human eye to recognize “colors” that are blends of the toner dots at particular locations.

FIG. 2 provides an alternative illustration of the sequential image formation. As the Cyan image is burned, a Cyan line 76 is etched into the hard substrate surface 28. Simultaneously with such surface etching fused Cyan particles 24a are formed in the etched surface. Subsequent passes with the laser at the respective power settings for each color etches a plurality of fused Magenta particles 24b and a plurality of fused Yellow particles 24c—all of which are strongly attached to the hard substrate surface 28.

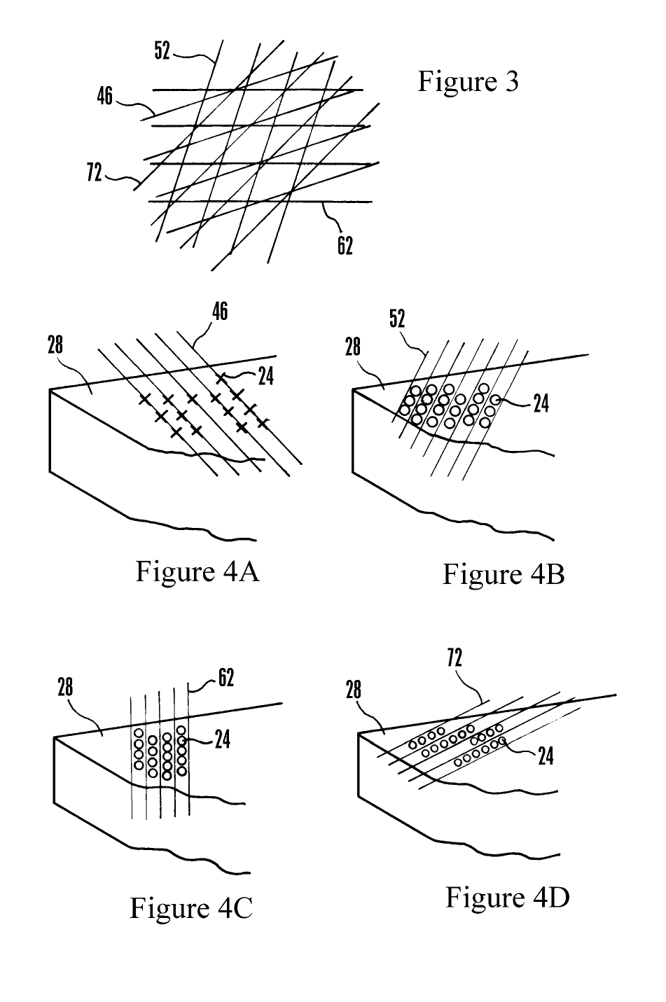

An alternative view of the manner in which separated color images are applied to the hard substrate surface 28 is illustrated in FIG. 3. The Cyan image is applied through a laser tracking over the surface to etch and embed the colored toner particles at the Cyan burn angle 46 of preferably 18.4350°. The subsequent Magenta burn angle 52 is preferably 71.565°, followed by application of the Yellow “separation” file (as that term is used in CorelDraw®—analogous to a “plate” used if printing) at the Yellow burn angle 62 of 0°. The final black image that brings final definition to the three colored images just formed is applied at the black burn angle of preferably 45°. Again, it should be understood that the “burn angle” for each pass refers to the selected screen angle used during the color separation process rather than to the direction of movement of the laser.

With occasional reference to FIGS. 4A-4D, the method of applying the graphic image 10 to the hard substrate surface 28 will now be described in accordance with a preferred embodiment of the present invention. Color toner (preferably obtained from TherMark Corporation of Los Angeles, Calif.) is initially mixed with denatured alcohol to obtain a consistency similar to 10W motor oil. The toner/alcohol mixture is placed in an airbrush bottle and applied to the hard substrate surface by spraying at approximately 35 pounds of air pressure. At this pressure the individual toner particles are quite small and enable a very light, even, translucent coating to be obtained on the hard substrate surface.

The digitized image file should be sized at 300 dpi (dots or pixels per inch) and in the CMYK color mode prior to initiating the application of the separated color layer images (termed color “separations” as discussed above) in order to match the resolution of the image file to the resolution of the laser (e.g., 300 dpi for a 300 ppi (points per inch) laser). The ceramic or glass substrate is then secured in position on a level surface, and the laser (not shown in the figures) is placed in its initiation or starting position. In addition to securement in the x-y plane, it is important to establish and maintain an appropriate distance in the z direction between the laser tip and the hard substrate surface, as discussed below.

In FIG. 4A the initial burn occurs using the first color (Cyan) at the Cyan burn angle (color separation screen angle) 46 of 18.4350°. The laser, preferably a “LaserPro® Explorer II” manufactured by GCC America, Inc., of Walnut, Calif., is provided with several “print” settings. The laser driver is used within an illustration software program, preferably CorelDraw® or PhotoShop® or another suitable program having color separation capabilities. The graphics file is imported into the software program (e.g., CorelDraw®, PhotoShop®, or the like) in order to set the substrate size, control color management, and set the print preferences, such as: print separations; line-screen frequency; and REP (rasterize entire page—equivalent to the file dpi). In such programs the “color management” feature is a saved profile used to best coordinate the information between the graphic file, the monitor, and the output laser file to ensure the laser interprets the closest match between the on-screen colors and the printed colors.

Some additional settings for the first color (Cyan) for CorelDraw® include:
(1) Radial Dot: Black & White
(2) Properties: DPI at 300
(3) Smart Act: Check Box (yes)

Several “pen” settings in CorelDraw® for the laser are preferably as follows for the first color (Cyan):
(1) Pen Color: Cyan
(2) Speed: 20 (value)
(3) Power: 29 (value)
(4) PPI: 300
(5) Raster: Yes
(6) Vector: No
(7) Air: No

Small crosses in FIG. 4A indicate the fused colored particles 24 formed by the laser at the above settings when creating the Cyan separated color image upon the hard substrate surface 28.

The surface is first washed with a sponge and water to remove the non-fused toner. The substrate is next drenched with denatured alcohol, patted dry with a paper towel, and thoroughly dried using a heat gun. The Magenta toner is next airbrushed over the dried hard substrate surface 28. The Magenta image is then formed at the Magenta burn angle (color separation screen angle) 52 of 71.565°.

Print settings in CorelDraw® for the laser are preferably as follows for the second color (Magenta):
(1) Radial Dot: Black & White
(2) Properties: DPI at 300
(3) Smart Act: Check Box (yes)

Several “pen” settings in CorelDraw® for the laser are preferably as follows for the second color (Magenta):
(1) Pen Color: Magenta
(2) Speed: 20 (value)
(3) Power: 15 (value)
(4) PPI: 300
(5) Raster: Yes
(6) Vector: No
(7) Air: No

Small circles in FIG. 4B indicated the fused colored particles 24 formed by the laser at the above settings when creating the Magenta separated color image upon the hard substrate surface 28.

The surface is again washed and dried, as described above, and the third color (Yellow) is next airbrushed over the hard substrate surface. A burned image is then obtained at the Yellow burn angle (color separation screen angle) 62 of 0°.

Print settings in CorelDraw® for the laser are preferably as follows for the third color (Yellow):
(1) Radial Dot: Black & White
(2) Properties: DPI at 300
(3) Smart Act: Check Box (yes)

Several “pen” settings in CorelDraw® for the laser are preferably as follows for the third color (Yellow):
(1) Pen Color: Yellow
(2) Speed: 20 (value)
(3) Power: 25 (value)
(4) PPI: 300
(5) Raster: Yes
(6) Vector: No
(7) Air: No

Small circles in FIG. 4C indicated the fused colored particles 24 formed by the laser at the above settings when creating the Yellow separated color image upon the hard substrate surface 28.

The unfused Yellow toner is then removed, the surface is dried as described above, and the fourth and final color to be burned (black)is then applied to the hard substrate surface 28 (see FIG. 4D). As may be recalled, black is used to add definition to the subtractive image by eliminating muddied colors and thus causing the desired colors to be emphasized. This black image is established at the black burn angle (color separation screen angle) 72 of 45°.

Print settings in CorelDraw® for the laser are preferably as follows for the fourth color (black):
(1) Radial Dot: Black & White
(2) Properties: DPI at 300
(3) Smart Act: Check Box (yes)

Several “pen” settings in CorelDraw® for the laser are preferably as follows for the fourth color (black):
(1) Pen Color: Black
(2) Speed: 20 (value)
(3) Power: 15 (value)
(4) PPI: 300
(5) Raster: Yes
(6) Vector: No
(7) Air: No

Small circles in FIG. 4D indicate the fused colored particles 24 formed by the laser at the above settings when creating the black separation upon the hard substrate surface 28.

The resulting image reproduces the digitized image in a manner that produces millions of different colors. The completed image is then completed by washing to remove the unfused black toner particles and drying. The image may then be sealed using an automotive finish or other coating chemicals.

It is to be understood and appreciated that the foregoing settings and steps can be altered, and, in some cases, must be altered depending upon the type of laser used and based upon the nature and quality of the digitized image—or the substrate; glass, for example may require a slight variation in the laser power settings. Additionally, some images include greater amounts of green, and a six color process—Hexachrome Separations as provided in CorelDraw®, adding orange and green images, results in a better reproduction of that image.

When it is desired to use a 6-color image reproduction process, the colors will be part of a hexachrome group, and it is necessary to convert the digitized file format to RGB to make the hexachrome separations available for use.

The following additions can then be made in the pen settings in CorelDraw® for the fifth image:
(1) Pen Color: Orange
(2) Speed: 20 (value)
(3) Power: 11 (value)
(4) PPI: 300
(5) Raster: Yes
(6) Vector: No
(7) Air: No

The following additions can then be made in the pen settings in CorelDraw® for the fifth image:
(1) Pen Color: Green
(2) Speed: 20 (value)
(3) Power: 16 (value)
(4) PPI: 300
(5) Raster: Yes
(6) Vector: No
(7) Air: No

The orange image is burned at the same angle as for Cyan (18.4350° at 133.8710), and the green burn angle is the same as for Magenta (71.5650° at 133.8710).

The further “printing” variable shown above (“133.8710”) is the line screen angle or lines per inch, also known as “frequency” in CorelDraw®. Access to this setting is obtained through the Print Separations, Advance Settings. To obtain access requires first selecting the Postscript Printer. Once Advance Settings is obtained, screening technology is set: RT Screening-Lino 300; Resolution 1270. Once set and saved, upon returning to the General Tab, “Explorer” is selected as the printer. The line screen frequency will then be pre-set for each CYMK separation in the Separations Tab. The Cyan and Magenta are as set forth above, Yellow is 127.0000 and Black (“K”) is 119.7370 When selecting the Hexachrome setting, the line-screen frequency will be added to the Orange (“O”) and green (“G”) separations as discussed above.

Continued experimentation has also revealed that image quality improves by placing the laser slightly out of focus with respect to the hard substrate surface. For example, when burning Cyan, Black, and Orange images, the laser is preferably focused approximately 0.037 inch above the hard substrate surface, and when burning Magenta, Yellow, and Green images, the laser is preferably focused approximately 0.088 inch above the hard substrate surface. Such off-focusing has been accomplished by placing a piece material of appropriate thickness on the top of a blank substrate material to focus the laser. Then when the blank substrate and material are replaced with a coated substrate, the laser is focused the selected distance above the coated substrate. For example, the material of appropriate thickness advantageously comprises one or more feeler gauges, stacked as necessary, on top of the blank substrate. Continued experimentation suggests KNOWN Wavelengths for orange will have a focus at 0.0590″; KNOWN Wavelengths for green will have a focus at 0.0510″; KNOWN Wavelengths for Violet will have a focus at 0.040″; KNOWN Wavelengths for Indigo will have a focus at 0.0445″; Warm White has a focus at 0.061″ (this was tested and worked); and Cool White (having a blue tint) has a focus at 0.0493″ (has not been tested yet). However; further testing may reveal a far wider range of distance than what is currently in use, such as; 0.035″ through 0.090″.

The previous description is directed to the use of a LaserPro® Explorer II and CorelDraw®. It should be understood that other laser engraving systems and other imaging software can also be used advantageously with appropriate adjustments to the settings. For example, the Trotec Speedy 100 carbon dioxide laser engraving system from Trotec GmbH of Austria may also be used in combination to burn the color toner particles onto the top surface of the hard substrate material. In one application, the Trotec Speedy 100 operates at 333 dpi (dots per inch) instead of 300 dpi, and the settings for the imaging software are adjusted accordingly.

Further experiments have shown that the image on the hard substrate can be advantageously enhanced by adjusting the print parameters in the software imaging program. For example, in one embodiment, the halftone screen angles are set as 105 degrees for Cyan, 165 degrees for Magenta, 90 degrees for Yellow and 45 degrees for Black at a line frequency of 133 lpi (lines per inch). It has further been found that the time for burning each color onto the hard substrate can be reduced by increasing the power of the laser and increasing the speed. For example, in one advantageous embodiment, the power and speed settings for the 30-watt LaserPro® Explorer II operating at 300 ppi (pulses per inch) are:
Cyan: Power=42 (value) Speed=40 (value)
Magenta: Power=20 (value) Speed=40 (value)
Yellow: Power=35 (value) Speed=40 (value)
Black: Power=21 (value) Speed=40 (value)

Note that the values of the foregoing settings are particular settings that provide satisfactory results on a ceramic substrate. The values are not expressed in a specific unit of measurement. The settings may vary for other substrates and for other laser engravers and should be adjusted to provide the correct hues for the colors.

The following inks (e.g., toner particles in solution) have been found to provide satisfactory results on hard substrates of glass or ceramic:
Cyan: Thermark LMC48 blue marking ink
Magenta: Thermark LMC34 red marking ink
Yellow: Thermark LMC74 yellow marking ink
Black: Thermark LMC12 black marking ink
   The inks are commercially available from Thermark Holdings, 5015 Eagle Rock Boulevard, Suite 310, Los Angeles, Calif. 90041, USA, and are described, for example, in U.S. Pat. Nos. 6,075,223 and 6,313,436 to Harrison, and in EP 1 023 184 B1 to Thermark, LLC.

Further studies using the foregoing screen angles, power and speed settings, and ink selections have determined that the following offsets of the focal point of the laser from the top surface of the hard substrate provide excellent color hues:
Cyan: laser focused approximately 0.0475 inch above surface
Magenta: laser focused approximately 0.065 inch above surface
Yellow: laser focused approximately 0.057 inch above surface
Black: laser focused approximately 0.0475 inch above surface
   The offsets of the focal points may vary with different inks, different power settings and different settings of the dpi, ppi and screen angles.

Our invention has been disclosed in terms of a preferred embodiment thereof, which provides multi-color laser-etched images in hard substrate surfaces that are of great novelty and utility. Various changes, modifications, and alterations in the teachings of the present invention may be contemplated by those skilled in the art without departing from the intended spirit and scope thereof. It is intended that the present invention encompass such changes and modifications.

We claim:

1. A hard-surfaced substrate having a color image formed thereon, comprising:
a surface of the substrate;
a first layer of toner particles of a first color, the toner particles of the first color laser burned onto selected locations of the surface as color dots of the first color in accordance with digital data representing a first color separation of a color image at a first screen angle;
a second layer of toner particles of a second color, the toner particles of the second color laser burned onto selected locations of the surface as color dots of the second color in accordance with digital data representing a second color separation of the color image at a second screen angle, which is different than the first screen angle; and
at least a third layer of toner particles of a third color, the toner particles of the third color laser burned onto selected locations of the surface as color dots of the third color in accordance with digital data representing a third color separation of the color image at a third screen angle, which is different than the first screen angle and the second screen angle.

2. The hard-surfaced substrate of claim 1, further comprising a fourth layer of black toner particles laser burned onto selected locations of the surface as black color dots in accordance with digital data representing a fourth color separation at a fourth screen angle, which is different than the first screen angle, the second screen angle and the third screen angle.

3. The hard-surfaced substrate of claim 2, wherein:
the toner particles of the first color are burned onto the surface to form color dots of a first size;
the toner particles of the second color are burned onto the surface to form color dots of a second size;
the toner particles of the third color are burned onto the surface to form color dots of a third size; and
the black toner particles are burned onto the surface to form color dots of a fourth size.

4. The hard-surfaced substrate of claim 3, wherein:
the first color is Cyan;
the second color is Magenta;
the third color is Yellow;
the second size and the third size are larger than the first size; and
the fourth size is approximately the same as the first size.

5. The hard-surfaced substrate of claim 4, wherein:
the toner particles of the first color are burned onto the surface by a laser beam focused a first distance from the surface;
the toner particles of the second color are burned onto the surface by a laser beam focused a second distance from the surface, the second distance greater than the first distance;
the toner particles of the third color are burned onto the surface by a laser beam focused a third distance from the surface, the third distance greater than the first distance; and
the black toner particles are burned onto the surface by a laser beam focused at a fourth distance from the surface, the fourth distance approximately the same as the first distance.

6. A method of forming a high-resolution color image on a hard-surfaced substrate, comprising:
separating a digitized color image into at least first, second and third digital images representing the components of respective first, second and third colors in the digitized color image by using respective first, second and third screen angles;
placing a first toner layer having particles corresponding to the first color on a surface of the hard-surfaced substrate and positioning the hard-surfaced substrate with the surface proximate a digitally controlled laser source and offset from the focal point of the laser source by a first offset distance;
applying digital signals to the digitally controlled laser beam to apply laser energy to selected portions of the surface to fuse the particles corresponding to the first color on the surface;
removing unfused portions of the first toner layer from the surface;
placing a second toner layer having particles corresponding to the second color on the surface and positioning the hard-surfaced substrate with the surface proximate the digitally controlled laser source and offset from the focal point of the laser source by a second offset distance;
applying digital signals to the digitally controlled laser beam to apply laser energy to selected portions of the surface to fuse the particles corresponding to the second color on the surface;
removing unfused portions of the second toner layer from the surface;
placing a third toner layer having particles corresponding to the third color on the surface and positioning the hard-surfaced substrate with the surface proximate the digitally controlled laser source and offset from the focal point of the laser source by a third offset distance;
applying digital signals to the digitally controlled laser beam to apply laser energy to selected portions of the surface to fuse the particles corresponding to the third color on the surface; and
removing unfused portions of the third toner layer from the surface.

7. The method of claim 6, further comprising:
separating the digitized color image into at least a fourth digital image representing the black component of the digitized color image by using a fourth screen angle;
placing a fourth toner layer having black particles on the surface, and positioning the hard-surfaced substrate with the surface proximate the digitally controlled laser and offset from the focal point of the laser source by a fourth offset distance;
applying digital signals to the digitally controlled laser beam to apply laser energy to selected portions of the surface to fuse the black particles on the surface; and
removing unfused portions of the fourth toner layer from the surface.

8. The method of claim 7, wherein:
the toner particles of the first color are burned onto the surface to form color dots of a first size;
the toner particles of the second color are burned onto the surface to form color dots of a second size;
the toner particles of the third color are burned onto the surface to form color dots of a third size; and
the black toner particles are burned onto the surface to form color dots of a fourth size.

9. The method of claim 7, wherein:
the first color is Cyan;
the second color is Magenta;
the third color is Yellow;
the second size and the third size are larger than the first size; and
the fourth size is approximately the same as the first size.

10. The hard surfaced substrate of claim 9, wherein:
the first offset distance and the fourth offset distance are approximately the same;
the second offset distance is greater than the first offset distance; and
the third offset distance is greater than the first offset distance.

11. A color image formed on a hard surface comprising:
toner particles of a first color laser burned onto selected locations of the surface as color dots of the first color in accordance with digital data representing a first color separation of a color image at a first screen angle;
toner particles of a second color laser burned onto selected locations of the surface as color dots of the second color in accordance with digital data representing a second color separation of the color image at a second screen angle, which is different than the first screen angle;
toner particles of a third color laser burned onto selected locations of the surface as color dots of the third color in accordance with digital data representing a third color separation of the color image at a third screen angle, which is different than the first screen angle and the second screen angle; and
black toner particles laser burned onto selected locations of the surface as black color dots in accordance with digital data representing a fourth color separation of the color image at a fourth screen angle, which is different than the first screen angle, the second screen angle and the third screen angle.

12. The color image of claim 11, wherein:
the first toner particles of the first color are burned onto the surface by a laser beam focused a first distance from the surface;
the second toner particles of the second color are burned onto the surface by a laser beam focused a second distance from the surface;
the third toner particles of the third color are burned onto the surface by a laser beam focused a third distance from the surface; and
the black particles are burned onto the surface by a laser beam focused a black distance from the surface.
